(19) United States
(12) Patent Application Publication
(10) Pub. No.: US 2005/0193606 A1
(43) Pub. Date: Sep. 8, 2005

(54) Furniture having covered areas

(76) Inventors: Sandra N. Stangl, Mill Valley, CA (US); Mike Vance, San Francisco, CA (US)

Correspondence Address: Attn: Michael E. Dergosits;DERGOSITS & NOAH LLP, Suite 1450, Four Embarcadero Center, San Francisco, CA, 94111, US

(21) Appl. No.: 10/795,021

(22) Filed: Mar. 3, 2004

(51) Int. Cl. G09F 15/02

(52) U.S. Cl. 40/606.08; 40/611.03

(57) ABSTRACT

An article of furniture having multiple surfaces including a substantially horizontal top and substantially vertical sidewalls. At least one of these surfaces is provided with a substantially planar support layer, an article receiving layer and a removable outer substantially transparent window wherein the substantially transparent window is spaced from the article receiving layer and is selectively repositionable with respect to the at least one surface to facilitate the insertion and removal of objects from the article receiving layer.

### TECHNICAL FIELD

The present invention involves articles of furniture whose visual appearance can be altered and personalized to suit the needs of a user. Almost any piece of furniture such as media cabinets, bookshelves, desks and drawer dressers can be produced incorporating the present invention in order to provide the desired aesthetic appearance. Although the present invention can be used by virtually anyone, it is anticipated that it would appeal particularly to teens and young adults.

### BACKGROUND OF THE INVENTION

Virtually all furniture is composed of structural elements for providing function and stability and facia components to create a desired visual appearance. Facia can consist of a veneer providing a wood or wood-like appearance or a composite such as plastic sheeting to create a more high-tech look. In either case, once the furniture article has been created, little latitude is provided for change in its visual appear or in any way customizing the furniture article to suit the aesthetic tastes of the user.

It is quite commonplace for all furniture users to associate the furniture with personal memorabilia in order to either change the look and feel of the furniture to match room decor or mood or to personalize a working surface with personal photographs or mementos. For example, many workers who find themselves at a desk for long periods of time will display photographs of family members, friends or even pets below a glass or transparent protective surface covering the desktop. Teens will oftentimes redact photos of movie or rock stars from magazines and tape them to the doors or sidewalls of media cabinets. In such instances, prior attempts to accommodate this activity have proven to be limiting and somewhat less than ideally satisfactory.

When photographs are placed on a desktop and covered with protective glass, the photographic surfaces oftentimes adhere to the back surface of the glass particularly if the photographs have remained in place for an extended period of time. Later attempts to remove the photographs causes their destruction as portions of the photographs adhere to the glass surface. Further, objects placed upon a desk are limited to those which are two-dimensional, such as photographs or drawings as the inner surface of the glass is coplanar and is supported by the horizontal surface of the desktop.

In instances where teens wish to append memorabilia to, for example, a cabinet or armoir door, the possibility exists for the degrading of the door surface. Taped photographs to a door oftentimes can only be removed with a consequent delamination of a portion of the door facia or at least its outer finish. Thumb tacks have also been commonly used but they obviously create holes in the facia surface which, in effect, destroys any attempt to maintain a quality visual appearance. In addition, if small dolls, keychains or other three-dimensional objects are adhered to the door surface, they tend to protrude, inadvertently fall from their vertical support and generally interfere with the intended furniture function.

It is thus an object of the present invention to provide a unique solution to the above-noted shortcomings.

It is a further object of the present invention to provide a novel line of furniture which is capable of being highly personalized in a way which satisfies the aesthetic needs of a user and yet avoids the limitations of the prior art.

These and further objects will be more readily apparent in considering the following disclosure and appended claims.

### SUMMARY OF THE INVENTION

The present invention is directed to an article of furniture having multiple surfaces which include a substantially horizontal top and substantially vertical sidewalls. It is contemplated that at least one surface be provided with a substantially planar support layer, an article receiving layer and a removable outer substantially transparent window which is spaced from the article receiving layer and selectively repositionable with respect to the at least one surface to facilitate the insertion and removal of objects from the article receiving layer.

### BRIEF DESCRIPTION OF THE DRAWINGS

FIG. 1 is a perspective view of a media cabinet configured according to the present invention.

FIG. 2 is a cross sectional view taken along line 2-2 of FIG. 1.

FIG. 3 is a perspective view of a coffee or support table produced according to the present invention.

FIG. 4 is a cross sectional view taken along line 4-4 of FIG. 3.

FIG. 5 is a perspective view of a drawer cabinet produced pursuant to the present invention.

FIG. 6 is a perspective view of a bookcase produced pursuant to the present invention.

FIGS. 7 and 8 are perspective views of a desk produced according to the present invention showing the subject transparent window in place and as being partially removed.

### DETAILED DESCRIPTION OF THE INVENTION

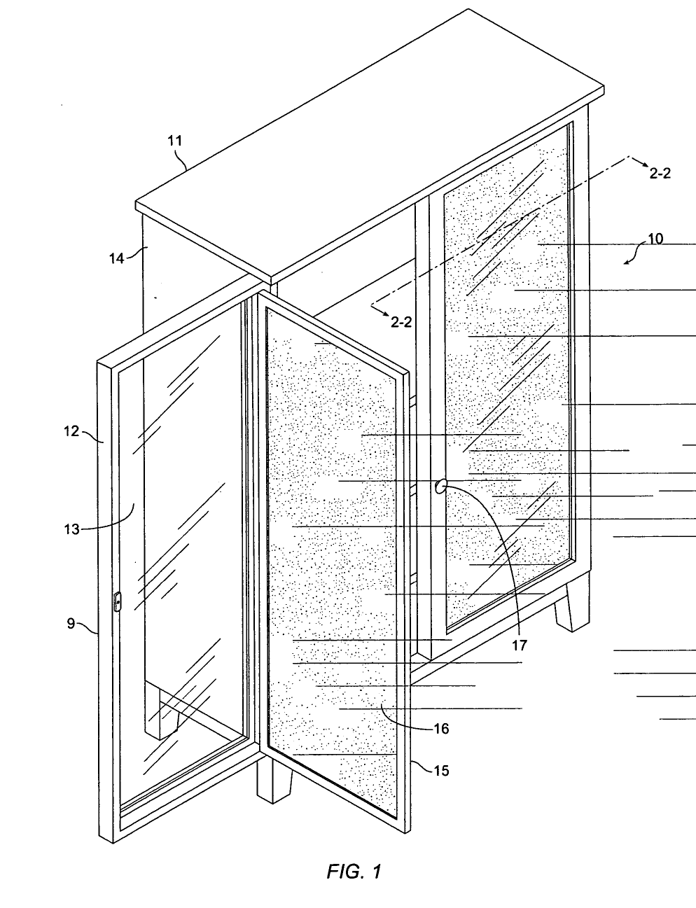

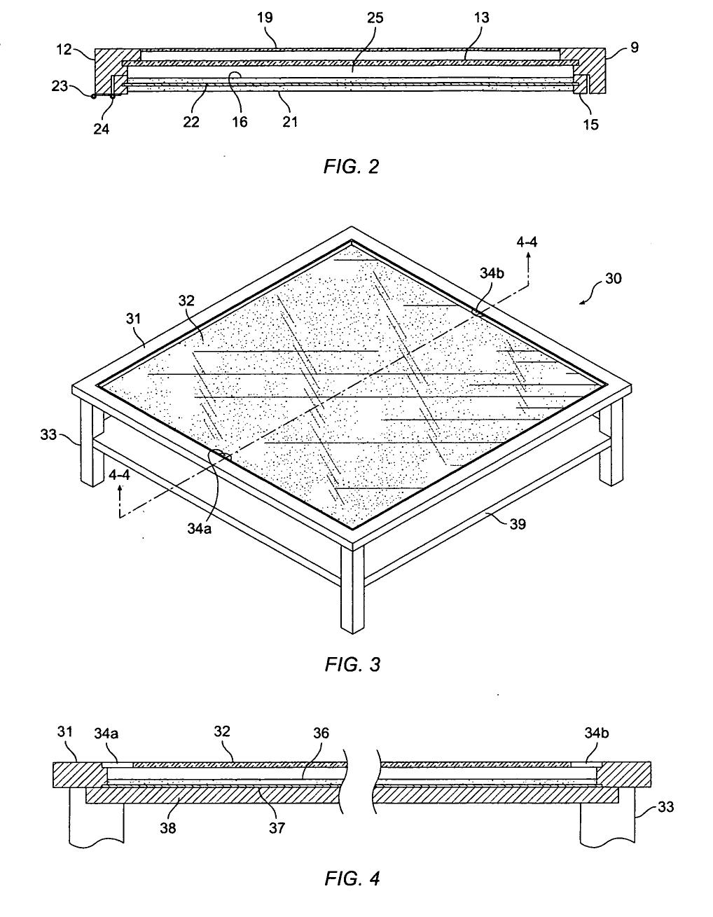

As noted previously, the present invention involves an article of furniture having multiple surfaces. One iteration of the present invention is shown in FIG. 1 as media cabinet 10. The media cabinet is provided with substantially horizontal top surface 11 and substantially vertical sidewalls 14. The version of the present invention in the form of a media cabinet can best be visualized in considering FIGS. 1 and 2.

Door 9 is shown as being substantially vertical. It is characterized as having an outer door frame 12 hingedly appended through hinge 23 (FIG. 2) for swinging engagement to substantially vertical sidewall 14. Door 9 is provided with an inner frame 15 which is in turn hingedly appended to substantially vertical sidewall 14 through the use of hinge 24. As such, outer frame 12 and inner frame 15 can be independently moved with respect to one another while remaining hinged to media cabinet 10.

Turning again to FIG. 1, outer frame 12 is shown as providing the peripheral edge for substantially transparent window 13. Inner door frame 15 provides the peripheral support for planar support member 22 and one or more article receiving layers 16 and 21 which can be composed of a relatively soft resilient material capable of receiving tacks or similar attachment means. It has been determined that cork would be an ideal article receiving layer for use in the present invention. As a further optional expedient, a second transparent surface 19 can be applied as shown in FIG. 2.

In operation, a user of cabinet 10 can grasp knob 17 and pull outer frame 12 from inner frame 15 thus exposing article receiving layer 16. Various two-and-three dimensional objects could thus be applied to article receiving layer 16 whereupon frame 15 can be reapplied to the inner edge of outer frame 12. It is an important feature of the present invention to note that, as best visualized by reference to FIG. 2, a significant space 25 is provided between substantially transparent window 13 and inner article receiving layer 16 so that once door 9 is fully closed, sufficient space is provided between these various layers to enable one to apply three-dimensional objects and even thumb tacks having substantial depth to article receiving layer 16 while still enabling door 9 to fully close. This feature of the present invention is important in differentiating the furniture articles of the present invention from its predecessors. Ideally, space 25 should be approximately ½ inch to 3 inches.

In addition to configuring the present invention into a substantially vertical door as depicted by reference to media cabinet 10, it can also be applied to a substantially horizontal surface as shown in the remaining embodiments discussed hereinafter. For example, FIG. 3 is directed to a coffee or support table. Table 30 can be used to simply operate as a decorative furniture article or it could be used to support other objects such as a television or stereo system. Table 30 consists of substantially vertical legs 33, lower shelf 39 and a substantially horizontal top in the form of frame 31 which defines the perimeter of substantially transparent window 32.

In referring to FIG. 4, it is noted that substantially transparent window 32 is supported by frame 31 and is spaced apart from article receiving layer 36 by free space 35. As was the case with FIG. 2, spacing 35 is critical in practicing the present invention and is ideally approximately 12 inch to 3 inches to accommodate both two-and-three dimensional objects for placement upon article receiving layer 36 which is in turn supported by substantially planar support layer 37. As an alternate expedient, substantially planar support layer 37 could be eliminated enabling article receiving layer 36 to reside directly upon structural support member 38. Cutout portions 34a and 34b are configured within substantially transparent window 32 to enable one to grip substantially transparent window 32 for its removal from frame 31 for applying and removing personal items to the surface of article receving layer 36.

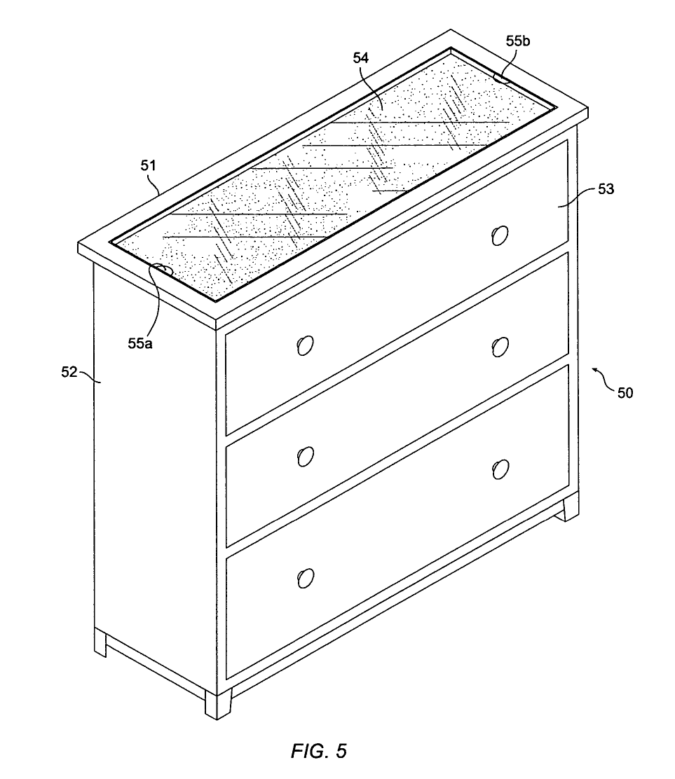

FIG. 5 depicts a drawer dresser including substantially vertical sidewall 52, drawers 53 and a substantially horizontal top which is configured of the various elements of the present invention. As shown in FIG. 5, frame 51 is shown as delineating the perimeter of substantially transparent window 54. The remaining elements within the substantially horizontal top are virtually identical to those constituting FIG. 4 and include cutout portions 55a and 55b to facilitate removal of substantially transparent window 54 from frame 51.

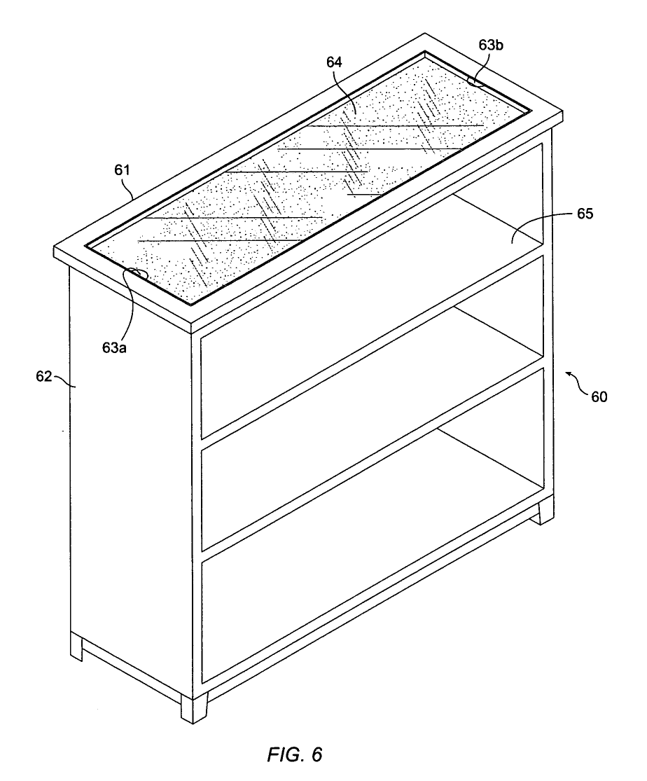

FIG. 6 depicts a bookcase again embracing the various elements of the present invention. Specifically, bookcase 60 is provided with substantially vertical sidewalls 62 and and a series of substantially horizontal supports 65 capped by a substantially horizontal top surface. The top surface includes frame member 61 which defines the perimeter of substantially transparent window 64. The remaining elements of the invention as depicted in FIG. 6 include the various article receiving and planar support layers such as those shown in FIG. 4. Substantially transparent window 64 is also provided with cutout region 63a and 63b to facilitate its removal.

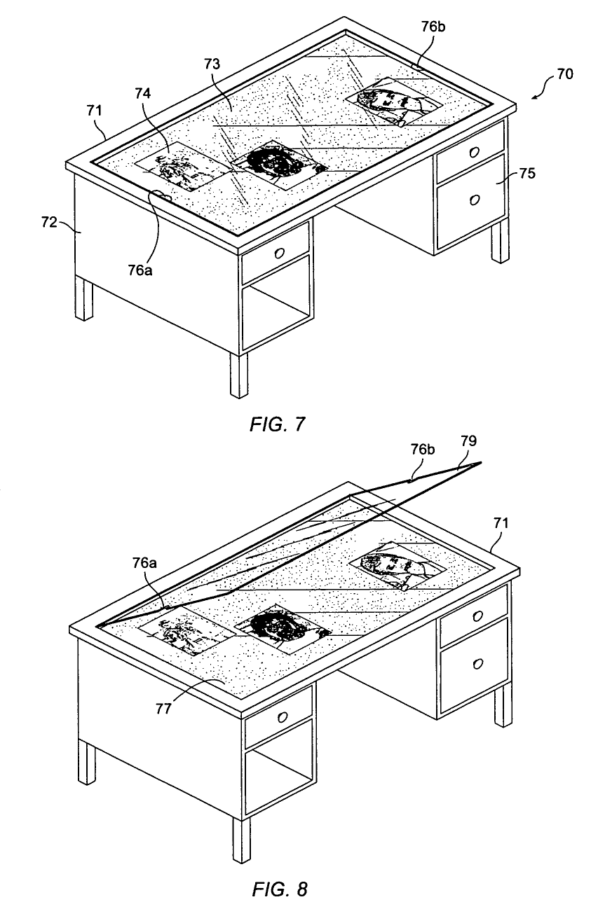

FIGS. 7 and 8 depict desk 70, again having the elements of the present invention. Substantially vertical sidewalls 72 are provided which help to define a region supporting drawers 75. The top surface of desk 70 is provided with frame 71 defining the perimeter of substantially transparent window 73. Desk 70 is further shown with the application of various pictures applied to substantially planar article receiving layer 77 which, again, could be cork facilitating the acceptance of tacks and other article attachment means without experiencing significant degradation. As noted by reference to FIG. 8, one could employ cutout region 76a and 76b to lift substantially transparent window 73 from frame 71 in order to enable one to gain access to article receiving layer 77. Although FIG. 8 shows substantially transparent window tipped away from the surface of frame 71, it could be entirely removed from desk 70 if desired.

In summary, the present invention as shown is one which enables a user to personalize the look of virtually any type of furniture not only by being able to apply two-dimensional objects such as pictures to the furniture article but also three-dimensional attachment means as well as small dolls or other three-dimensional objects of art without degrading the furniture in any significant fashion while avoiding the application of any such personal items to an exterior surface of the furniture which might otherwise compromise its utility.

1. In an article of furniture having multiple surfaces including a substantially horizontal top and substantially vertical sidewalls, the improvement comprising providing at least one surface with an article receiving layer and a removable outer substantially transparent window wherein said substantially transparent window is spaced from said article receiving layer and is selectively repositionable with respect to said at least one surface to facilitate the insertion and removal of objects from said article receiving layer.

2. The article of claim 1 wherein said at least one surface comprises a door hingedly appended to a substantially vertical edge of said furniture.

3. The article of claim 2 wherein said substantially transparent window is hingedly appended to said substantially vertical edge of said furniture.

4. The article of claim 1 further comprising a substantially planar support layer in contact with said article receiving layer.

5. The article of claim 2 wherein said article receiving layer comprises a substantially planar cork sheet and said substantially transparent window is spaced from said cork sheet a sufficient distance to provide for selective attachment of objects onto said cork sheet while not preventing closure of said substantially transparent window onto said door.

6. A cabinet comprising a substantially vertical top, substantially vertical back and sidewalls and at least one door, said door characterized as having an inner door frame hingedly appended for swinging engagement to one of said sidewalls and being provided with a planar support connected to said inner door frame, an article receiving layer applied to said planar support, a substantially transparent window encased within an outer window frame hingedly connected to said one of said sidewalls such that said outer window frame is swingable from said outer door frame independent of the positioning of said door with respect to said one of said sidewalls wherein said substantially transparent window is spaced from said article receiving layer.

7. The cabinet of claim 6 wherein said article receiving layer comprises a substantially planar cork sheet and said substantially transparent window is spaced from said cork sheet a sufficient distance to provide for selective attachment of objects onto said cork sheet while not preventing closure of said substantially transparent window onto said door.

8. In an article of furniture having multiple surfaces including a substantially horizontal top and substantially vertical sidewalls, the improvement comprising providing said substantially horizontal top with an article receiving layer and a removable outer substantially transparent window wherein said substantially transparent window is spaced from said article receiving layer and is selectively removable from said substantially horizontal top to facilitate the access to said article receiving layer for the insertion and removal of objects therefrom.

9. The article of claim 8 further comprising a substantially planar support layer in contact with said article receiving layer.

10. The article of claim 8 wherein said substantially transparent window is characterized as having at least one cutout portion for gripping to facilitate its removal from said substantially horizontal top surface.

11. The article of claim 10 wherein said furniture comprises a drawer cabinet.

12. The article of claim 10 wherein said furniture comprises a shelf.

13. The article of claim 10 wherein said furniture comprises a stand.

14. The article of claim 10 wherein said furniture comprises a storage base.

15. The article of claim 10 wherein said furniture comprises a bookshelf.

16. The article of claim 10 wherein said furniture comprises a desk.

17. The article of claim 10 wherein said furniture comprises a drawer dresser.

18. The article of claim 1 wherein said substantially transparent window is spaced from said article receiving layer by a distance of approximately ½ inch to 3 inches.

19. The article of claim 8 wherein said substantially transparent window is spaced from said article receiving layer by a distance of approximately ½ inch to 3 inches.
